(19) United States
(12) Patent Application Publication
(10) Pub. No.: US 2004/0132503 A1
(43) Pub. Date: Jul. 8, 2004

(54) Thermal management for telecommunication devices

(76) Inventor: Chia-Pin Chiu, Tempe, AZ (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/336,629

(22) Filed: Jan. 3, 2003

(51) Int. Cl. H04M 1/00

(52) U.S. Cl. 455/575.1; 379/433.08

(57) ABSTRACT

A thermal management method and apparatus for the heat-producing microelectronic package(s) contained within an enclosure also comprising a battery. In one embodiment in accordance with the present invention, the heat-producing microelectronic package(s) contained within a wireless phone enclosure is placed in thermal communication with the battery. The battery is therefore utilized as a thermal mass that absorbs and dissipates the heat during operation. The battery is provided to re-conduct the thermal energy back to the microelectronic package and to the thermally conductive circuit substrate for dissipation. In another embodiment, the battery is provided to conduct the thermal energy to a thermal conductive enclosure exterior side.

### FIELD OF THE INVENTION

The present invention relates to telecommunication devices and, more particularly, to thermal management in wireless handsets.

### BACKGROUND OF INVENTION

Wireless phone technology is advancing beyond simply making a phone call to providing extensive connectivity and content features. Along with the advanced features is the requirement that the microelectronics within the phone provide more capability with faster processing. The microelectronics associated with these activities are usually packaged within one or a few multifunctional microelectronic packages. These microelectronic packages generate significant amounts of heat during use that must be dissipated to prevent damage. The concentrated heating and small size of the enclosure make thermal management a significant issue in wireless phone design.

FIG. 1 is a cross-sectional view of a simplified representation of a common wireless phone 2. The wireless phone 2 comprises an enclosure 4, display electronics 6, a battery 8, a keypad 14, and a circuit substrate 10. The very small volume within a wireless phone enclosure 4 requires efficient utilization of space to contain the various components. The display electronics 6 and the keypad 14 require exposure to the front side 7 of the enclosure 4.

The battery 8 is located adjacent the backside 11 of the enclosure 4 and occupies a significant volume within the enclosure 4. The battery 8 is required to be user-accessible and replaceable, therefore, the battery 8 is contained within a battery enclosure 16 and accessed through the backside 11 through an access cover 5. The battery enclosure 16 is segregated and sealed from the remaining volume within the enclosure 4 to protect the remaining volume from contamination.

The circuit substrate 10 provides mounting and electrical interconnections for the majority of the electronic components of the wireless phone 2. Contact switches controlled by the keypad 14 are commonly found on one side of the circuit substrate 10, and the electronic devices, including one or more heat-producing microelectronic packages 12 discussed above, are located on the side 13 proximate the battery enclosure 21.

The heat from the microelectronic package 12 is conducted to the circuit substrate 10 that is made thermally conductive for that purpose. The heat is then released by convection to the environment. However, the heat spreading effect of the circuit substrate 10 is less effective as the size of the circuit substrate 10 is reduced for the smaller sizes of wireless phones. Further, the limited space inside the enclosure 4 is not sufficient to support thermal convection of the heat produced by advanced microelectronic packages 12.

New apparatus and methods are needed for managing the high temperatures produced by advanced microelectronic packages contained in wireless phones. They should conform to the form factor of current and future wireless phones, be capable of managing the thermal requirements of future microelectronic packages, and be inexpensive to manufacture.

### BRIEF DESCRIPTION OF DRAWINGS

FIG. 1 is a side cross-sectional view of a commonly configured wireless phone;

FIG. 2 is a side cross-sectional view of a thermal management system for wireless phones, in accordance with an embodiment of the present invention;

FIG. 3 shows temperature profiles for the microelectronic package for a short operation period; and

FIG. 4 shows temperature profiles for the microelectronic package for a long operation period.

### DESCRIPTION

In the following detailed description, reference is made to the accompanying drawings which form a part hereof wherein like numerals designate like parts throughout, and in which is shown by way of illustration specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

Embodiments of the present invention provide, by way of example, thermal management for the heat-producing microelectronic package(s) contained within the wireless phone enclosure. The heat-producing microelectronic package(s) is placed in thermal communication with the battery. The battery is therefore utilized as a thermal mass that absorbs and dissipates the heat during operation. The embodiments of the present invention are not limited to providing thermal management for a microelectronic package, but any source within the wireless phone enclosure requiring thermal management, either to provide heat or to reject heat.

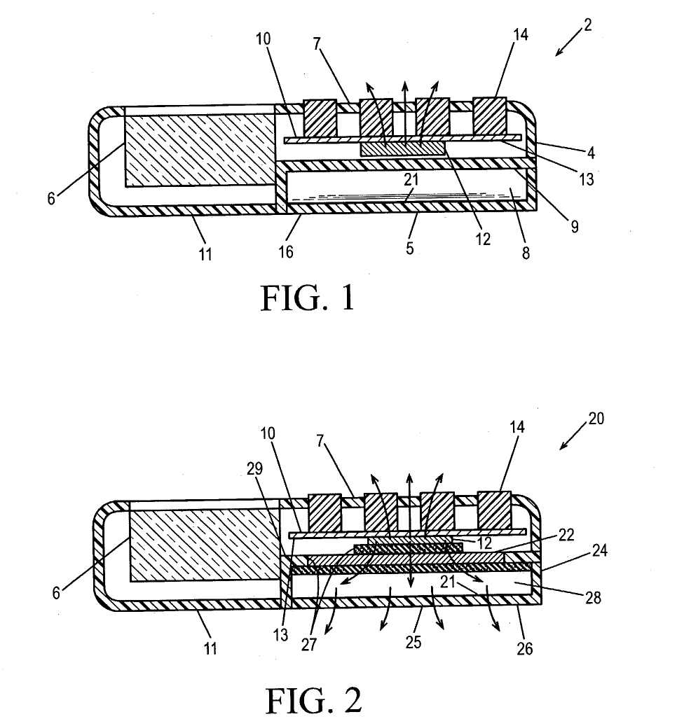

FIG. 2 is a side cross-sectional view of a thermal management system for a wireless phone 20, in accordance with an embodiment of the present invention. The wireless phone 20 comprises an enclosure 24, display electronics 6, a battery 28, a keypad 14, and a circuit substrate 10 of substantially the same configuration as the embodiment of FIG. 1.

The battery 28 is located adjacent the backside 11 of the enclosure 24. The battery 28 is contained within a battery enclosure 26 and accessed through the backside 11 through an access cover 25. The battery enclosure 26 is segregated and sealed from the remaining volume within the enclosure 24 to protect the remaining volume from contamination.

The circuit substrate 10 remains substantially the same configuration as the embodiment of FIG. 1. The heat-producing microelectronic package(s) 12 is coupled to the circuit substrate 10 on the side 13 proximate the battery enclosure 26.

The battery enclosure 26 comprises an interior side 29 adjacent the microelectronic package(s) 12. The interior side 29 separates the battery 28 from the microelectronic package(s) 12. At least a portion of the interior side 29 comprises a heat transfer portion 22 comprising a material having a significant thermal conduction property. Such material includes, but is not limited to, metals and thermally-conductive plastics.

Thermal contact medium 27 is provided between and in thermal contact with the microelectronic package(s) 12 and the heat transfer portion 22. Additional thermal contact medium 27 is provided between and in thermal contact with the battery 28 and the heat transfer portion 22.

The thermal contact medium 27 comprises a material having thermal conducting properties suitable to thermally interconnect thermal conductive components. A material further comprising a compliant property, such as, but not limited to, a thermal conducting silicone pad, assists to ensure intimate contact between components for efficient thermal transfer.

When the wireless phone 20 is in operation, a portion of the heat from the microelectronic package 12 is conducted through the thermal contact medium 27 and the heat transfer portion 22 to the battery 28. The other portion of the heat is conducted to the circuit substrate 10 and dissipated therefrom. The temperature rise of the microelectronic package 12 is thereby reduced.

The battery 28 has a large thermal mass that is capable of absorbing a significant amount of thermal energy. When the wireless phone 20 is not in operation, the battery 28 slowly releases the stored thermal energy through the thermal contact medium 27 and the heat transfer portion 22 to the microelectronic package 12, and subsequently conducted to the circuit substrate 10 and dissipated by convection to the environment. This process is referred herein as two-way thermal transfer.

In other embodiments of the present invention, the transfer of thermal energy into and out of the battery 28 is facilitated with at least a portion of the battery case (not shown) comprising a material having a significant thermal conductive property. Such material includes, but is not limited to, metals and thermally conductive plastics.

In yet other embodiments of the present invention, at least a portion of the backside 11 and/or the access cover 25, comprise a material having a significant thermal conductive property. In operation, the thermal energy from the microelectronic package(s) 12 to the battery 28 is further transferred out of the battery 28 and through the backside 11 and/or the access cover 25 to the environment. In these embodiments, the battery 28 acts more as a thermal pass-through component rather than a thermal storage component. This process is referred herein as one-way thermal transfer.

Further, in the one-way thermal transfer embodiments, the use of a thermally conducting circuit substrate 10 is of lessor importance as the circuit substrate 10 is not the primary thermal transfer path.

When the wireless phone 20 is in operation, the heat generated by the microelectronic package 12 is absorbed by the thermal mass contributed by the battery 28, such that the temperature rise of the microelectronic package(s) 12 is reduced. When the wireless phone 20 is in idle model, the heat stored in the battery 28 is slowly released back to the microelectronic package(s) 12 and then dissipated to the external ambient.

During long usage periods, the wireless phone 20 will eventually reach a steady-state temperature that is lower than the case without thermal contact between the microelectronic package 12 and the battery 28. This is because the heat transfer portion 22 and the battery 28 create an additional heat transfer path in addition to the circuit substrate 10 and the keypad 14. Since the battery 28 has a much larger surface area than the microelectronic package 12, convection will be more efficient and the overall thermal resistance is reduced.

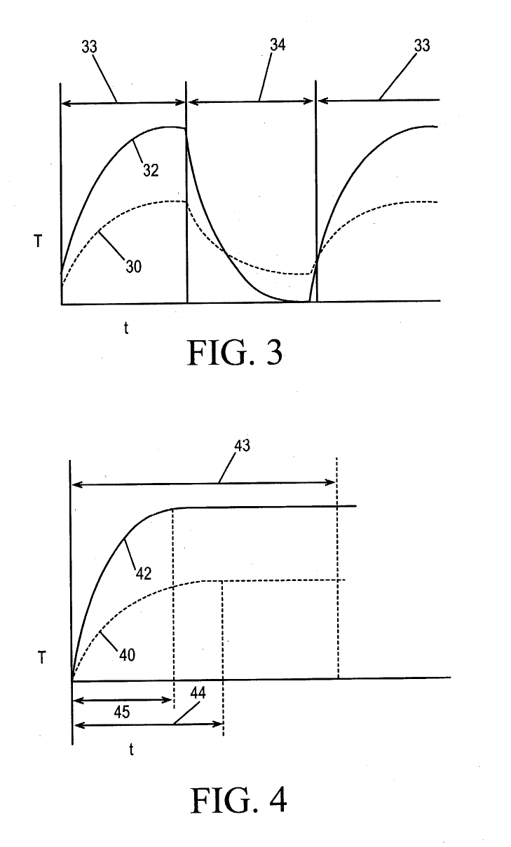

FIG. 3 shows temperature profiles 30, 32 for the microelectronic package(s) 12 in the wireless phone 20 of FIG. 2, and the wireless phone 2 of FIG. 1, respectively, for a short operation period 33. It can be seen that the temperature rise during wireless phone operation period 33 is significantly reduced in the wireless phone 20 of FIG. 2. It can also be seen that the microelectronic package(s) 12 will be warmer during the idle period 34 for the wireless phone 20 of FIG. 2. Thus, the temperature range of the microelectronic package 12 is smaller between operations 33 and idle periods 34, resulting in a more reliable microelectronic package 12 lifetime.

FIG. 4 shows temperature profiles 40, 42 for the microelectronic package(s) 12 in the wireless phone 20 of FIG. 2, and the wireless phone 2 of FIG. 1, respectively, for a long operation period 43. It can be seen that the wireless phone 20 of FIG. 2 has a reduced steady-state peak temperature and also an increased time constant required to reach the steady state, both of which result in a more reliable microelectronic package 12 lifetime.

Wireless phones using embodiments of the present invention can be made to operate and perform better in low temperature environments. A wireless phone with a cold battery may temporarily not work, regardless of the state of charge. The NiMH battery performance is particularly limited in temperatures below 14° F. (−10° C.). The Li-lon battery performance is particularly limited in temperatures below 32° F. (0° C.). Thus, embodiments of the thermal management system, and in particular, embodiments of two-way thermal transfer, can be used to keep the battery warm in low temperatures to maintained functionality.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed is:

1. A thermal management method for a microelectronic package, comprising:
providing a thermal conduction path between the microelectronic package and a battery.

2. The thermal management method of claim 1, further comprising:
providing a thermal conduction path between the battery and the exterior of an enclosure through at least a portion of an exterior side of an enclosure that comprises a thermal conductive material.

3. The thermal management method of claim 1, further comprising:
providing a thermal conduction path between the microelectronic package and a thermal conductive circuit substrate upon which the microelectronic package is coupled, the microelectronic package is positioned mechanically in series between the circuit substrate and the battery.

4. The thermal management method of claim 2, further comprising:
providing a thermal conduction path between the microelectronic package and a thermal conductive circuit substrate upon which the microelectronic package is coupled, the microelectronic package is positioned mechanically in series between the circuit substrate and the battery.

5. The thermal management method of claim 3, further comprising:
enclosing the thermal conduction path in an enclosure of a wireless phone, a battery enclosure environmentally separating the battery from the microelectronic package, at least a portion of the thermal conduction path comprising:
the microelectronic package thermally in series with a thermal conducting medium, thermally in series with the thermal conductive interior heat transfer portion, thermally in series with a thermal conducting medium, thermally in series with the battery.

6. The thermal management method of claim 4, further comprising:
enclosing the thermal conduction path in an enclosure of a wireless phone, a battery enclosure environmentally separating the battery from the microelectronic package, at least a portion of the thermal conduction path comprising:
the microelectronic package thermally in series with a thermal conducting medium, thermally in series with the thermal conductive interior heat transfer portion, thermally in series with a thermal conducting medium, thermally in series with the battery; and
at least a portion of the thermal conduction path further comprising:
the microelectronic package thermally in series with the circuit substrate.

7. A thermal management method for a wireless phone, comprising:
providing a thermal conduction path between a heat producing source and a battery.

8. The thermal management method of claim 7, wherein providing a thermal conduction path between a heat producing source and a battery comprises:
providing a thermal conduction path between a microelectronic package and a battery.

9. The thermal management method of claim 8, further comprising:
providing a thermal conduction path between the battery and the exterior of an enclosure through at least a portion of an exterior side of an enclosure that comprises a thermal conductive material.

10. The thermal management method of claim 9, further comprising:
providing a thermal conduction path between the microelectronic package and a thermal conductive circuit substrate upon which the microelectronic package is coupled, the microelectronic package is positioned mechanically in series between the circuit substrate and the battery.

11. The thermal management method of claim 9, further comprising:
enclosing the thermal conduction path in an enclosure of a wireless phone, a battery enclosure environmentally separating the battery from the microelectronic package, at least a portion of the thermal conduction path comprising:
the microelectronic package thermally in series with a thermal conducting medium, thermally in series with the thermal conductive interior heat transfer portion, thermally in series with a thermal conducting medium, thermally in series with the battery.

12. The thermal management method of claim 10, further comprising:
enclosing the thermal conduction path in an enclosure of a wireless phone, a battery enclosure environmentally separating the battery from the microelectronic package, at least a portion of the thermal conduction path comprising:
the microelectronic package thermally in series with a thermal conducting medium, thermally in series with the thermal conductive interior heat transfer portion, thermally in series with a thermal conducting medium, thermally in series with the battery; and
at least a portion of the thermal conduction path further comprising:
the microelectronic package thermally in series with the circuit substrate.

13. The wireless phone of claim 12, wherein the thermal conducting medium is a compliant thermally conductive material.

14. A wireless phone comprising:
an enclosure;
a microelectronic package;
a battery;
a battery enclosure housing the battery, the battery enclosure comprising an interior side between the battery and the microelectronic package, at least a portion of the interior side comprising a thermal conductive interior heat transfer portion;
thermal conducting medium between and in intimate thermal contact with the battery and the heat transfer portion of the interior side; and
thermal conducting medium between and in intimate thermal contact with the microelectronic package and the heat transfer portion of the interior side.

15. The wireless phone of claim 14, wherein the heat transfer portion is a material selected from the group consisting of metals and thermally conductive plastics.

16. The wireless phone of claim 15, wherein the thermal conductive medium comprises a compliant thermally conductive silicone.

17. The wireless phone of claim 16, wherein the battery enclosure further comprises an exterior side, at least a portion of the exterior side comprising an exterior heat transfer portion having a significant thermal conduction property, the battery in thermal communication with the exterior heat transfer portion.

18. The wireless phone of claim 17, wherein the battery comprises a thermally conductive battery case in thermal communication with the interior heat transfer portion.

19. The wireless phone of claim 19, further comprising a thermally conductive circuit substrate, wherein the microelectronic package is in thermal communication with the circuit substrate.
